(19) United States
(12) Patent Application Publication
(10) Pub. No.: US 2009/0164787 A1
(43) Pub. Date: Jun. 25, 2009

(54) METHOD AND SYSTEM FOR THE TRANSMISSION OF IDENTIFICATION SIGNALS

(75) Inventors: Andreas Martin Haberli, Bubikon (CH); Andreas Stucki, Grut (CH); Alois Cavelti, Riedikon (CH)

Correspondence Address: RANKIN, HILL & CLARK LLP, 38210 Glenn Avenue, WILLOUGHBY, OH, 44094-7808, US

(73) Assignee: KABA AG, Wetzikon (CH)

(21) Appl. No.: 12/088,273

(22) PCT Filed: Sep. 26, 2006
(86) PCT No.: PCT/CH2006/000518

§ 371 Date: Sep. 30, 2008

(30) Foreign Application Priority Data
Sep. 27, 2005 (CH) 1568/05

(51) Int. Cl. H04L 9/32

(52) U.S. Cl. 713/173

(57) ABSTRACT

The invention relates to a system for information transmission between a write- and/or read installation and several portable devices. According to the invention, the information transmission between a portable device and the write- and/or read installation is effected via two channels. On the one hand a first information transmission takes place capacitively and preferably with the human body as a transmission medium. On the other hand, the information transmission procedure also includes a second or conventional “contactless” transmission, i.e. an inductive transmission or a transmission via electromagnetic waves, for example in the radio frequency-, microwave- or infrared range.

### BACKGROUND OF THE INVENTION

The invention relates to the communication between a write- and/or read installation and at least one portable device which a user carries with him and which serves as an information carrier.

According to the state of the art, such information carriers are designed as transponders and are increasingly applied as identification media for access control with mechatronic locking systems, for ticketing, for person identification and for further applications. Thereby, they replace or supplement mechanically coded keys, paper charge cards, paper tickets, identity document papers read by eye, etc. Integrated solutions with several applications on a single card or the integration of the identification medium into another object—for example a clock or a mechanically coded key—have already been suggested. Generally, the user carries the transponder with him. It is particularly with applications such as ticketing, but also with access control, that the transponder does not need to be linked to a certain person. Rather, it may indeed also be transferable or be designed as an electronic charge card. The transponder often, but not always, has a unique number which characterises it.

Contactless systems are of particular interest where a wireless information transfer between the transponder and a write- and read module takes place. The information transfer is generally reciprocal with such systems.

The disadvantage with contactless systems is the fact that they may not guarantee that the data transmission takes place in a person-selective manner. One may not exclude the write- and read module receiving signals which do not originate from the envisaged person (for example the person obtaining the access) but from another person present in the vicinity. Unauthorised access, collisions or multiple bookings may be the result, depending on the application. This creates a dilemma: for reasons of comfort, on the one hand it would be desirable if the information transfer were to be as far-reaching as possible: the user should not need to hold the transponder actively onto the write- and read module. On the other hand, only by way of a short-range information transmission which is locally limited as much as possible, may one ensure to some extent that the information transfer only takes place between the person obtaining access and the write- and read module.

A likewise known wireless system for information transmission is based on a capacitive coupling between a portable device and a write- and read module via the human body. Such systems for example are disclosed in the U.S. Pat. No. 4,591,854, the U.S. Pat. No. 5,914,701 and the U.S. Pat. No. 5,796,827. A user carries the portable device with him. Information flows as soon as the user contacts a contact surface coupled to the write-and read module. For example, an unique access code may be transmitted from the portable device to the write- and read module. The disadvantage with this system is the fact that only a limited data quantity may be transmitted on account of the poor signal-to-noise ratio. A good signal-to-noise ratio is only possible with a large amplitude of the transmission signal. A large amplitude (i.e. large voltage) is, however, not tolerated by the user.

Proceeding from this state of the art, it is the object of the invention to provide a method for the transmission of information between at least one write- and/or read installation, and a portable device, which overcomes the disadvantages of the state of the art and which in particular acts in a person-selective manner.

### BACKGROUND OF THE INVENTION

According to the invention, this object is essentially achieved in that the information transfer is effected by way of the portable device and a write- and/or read installation via two communication channels. On the one hand a first information transmission takes place in a capacitive manner, wherein a coupling may take place via the human body. On the other hand, the information transmission procedure also includes an information transmission via a second, for example conventional and “contactless” information channel. A “contactless” information channel here means an inductive transmission or a transmission via electromagnetic waves, for example in the radio frequency-, microwave frequency- or infra red range. This does not imply that a contact necessarily needs to take place for the transmission of information via the first communication channel.

Information transmitted via the first communication channel primarily serves for the identification and selection of the user. It contains, for example, an unique identification code. Information transmitted via the second communication channel is, for example, the actual transmitted information which also (under certain circumstances together with user data) is stored on the portable device and/or the write- and/or read installation.

Hereinafter, information transferred via the first communication channel is called “first information” (or “first data”), and the information transferred via the second information channel is called “second information” (or “second data”). This is independent of the sequence of the information transmission procedures, as well as whether the transmission of the first and/or second information only contains the unilateral transfer or the reciprocal exchange of information, and of whether only a single information package is transferred or whether a plurality of information packages, amongst other things in a hierarchised manner, is transferred.

The complete write- and/or read process—the exchange of the first and the second information—preferably takes place in a short time span, for example during a period of maximal 5 s, preferably during a period of maximal 2 s. Only by way of this, may one already ensure, depending on the arrangement of the write- and/or read installation, that the first and second information is exchanged with the same portable device. Further measures for ensuring the person selectivity, which will yet be explained in more detail in this text, are possible alternatively or supplementary to this “rapid” information transfer.

An unselective or user-unspecific information exchange for the preparation of the second information transfer, above all conceivable for the synchronisation and for the creation of the second communication channel, may be effected before the first information transfer. Preferably, but not necessarily, the actual second information transmission takes place after the first information transmission. This permits the particularly advantageous embodiment in which the first information transmission is a precondition for the second information transmission. For example, one verifies with the first information by way of the write- and/or read installation, as to whether the portable device is authorised to exchange information at all. Alternatively or supplementarily, by way of the portable device, one may inversely also verify by way of the portable device as to whether the write- and/or read installation is authorised for information exchange (for example for debiting a credit balance, etc). The actual write- and read processes then takes place by way of the—often reciprocal—second information transmission.

According to a particularly preferred embodiment, the person selectivity on exchange of the second information is ensured by yet additional measures. This is effected in that the second data is at least partly dependent on the first data. The receiver of the respective transmitted second data may then verify whether this originates from that participant which already took part in the first information transmission. The second data may, for example, be a function of the first data. Thus, the first data may be completely or partly contained in each data package of the second data or at least in one information package of the second data. The first data may also permit the write- and read installation to identify the portable device. The second data is then sent to the portable device from the write- and/or read installation and contains an address of the portable device. Alternatively or supplementarily to this, the first data may contain a key which may be used for the at least partial encoding of the second data. As a further alternative, the first data may also contain only a reference to a key present on both sides. Many further variants are conceivable.

Thus for the second data D₂, which contains second information I₂ (or packages thereof), the following applies:

D₂=f_{D1}(I₂)

wherein f_{D1} represents a function which is dependent on the first data D₁. This in the simplest case may look like:

D₂=(D₁, I₂)

i.e. the second data consists merely of a sequence of the first data with the second information to be transmitted. The receiver—thus the write- and/or read installation or the portable device—accepts the second data only on agreement with the first data. Otherwise, the received data do not originate from the “proper” participant.

An heightened security is ensured if the data D₁ contains a key K and when the following applies

D₂={I₂}_{K} or D₂=(Id, {I₂}K) or D₂={(I_{d}, I₂)}_{K} or D₂=(I_{d}, {(Id, I₂)}_{K}),

wherein Id represents an identification of the sender and {X}_{K} indicates the information X encoded with the key K. With the reciprocal information exchange, one may use the same key for both directions of the data transmission, or one may use various, under certain circumstances, alternating keys. The applied key is for example specific to the portable device and may be managed on the part of the write- and/or read installation with the “key diversification” procedure. Other encoding- or authentification procedural manners are of course also conceivable, for example also based on the public key/private key principle, etc.

The invention also relates to a system for implementing the method according to the invention, as well as a write- and/or read installation, and a portable device.

Systems for carrying out this method may be applied in a multitude of applications. The following list serves only as an example:
access control (systems of different complexity- and security degrees)
locking of objects (safe, etc.)
time- and presence acquisition
cashless monetary transactions
charge cards (for example prepaid—mobile telephones, parking fee credit, cash replacement, etc.)
access to data processing systems
biometric person control
ticketing (validating (stamping) entry tickets or travel tickets, debiting units from entry tickets or travel tickets, automated computation and charging of public transport fees etc.
secure data transfer
etc.

In combination with most of these applications, the method according to the invention, apart from additional security discussed, above also entails significant advantages with regard to the handling by the user. The apparent complication from the technical point of view—two information channels are required rather than only one—leads to a simplification for the user.

Thus, for example, the user may gain access to a property by way of actuating the door latch. He neither needs to fetch a card nor a key, nor does he need to input a code or carry out other manipulations (of course the possibility of a PIN-entry or other manipulation in combination with the method according to the invention for additional security is not ruled out). In contrast to the state of the art (for example “hands free access” to a vehicle) this also applies to a highly secure access control.

As a further example, when crediting or debiting charge cards, it is sufficient for the user to carry out the desired actions via keypad, if the keypad or a coupling surface of this is to be touched (or to be touched in a proximate manner) for activation, comprises an electrode for the capacitive data transmission. Here too, neither a PIN-entry nor the insertion of charge card in a slot, etc. is necessary.

A third example is person identification by way of biometric data. According to the state of the art, a user (in the case of fingerprints as a biometric feature) in a first step, must bring his finger in contact with a sensor, which creates a so-called template of the fingerprint.

Subsequently he must bring a personal data carrier (smart card or likewise) in contact with a reader; here a comparison of the measured biometric data with the stored biometric data takes place. Only then—on authorisation to the user—is the desired object unlocked. The method according to the invention permits the evaluation of a template and a secure data exchange to be carried out simultaneously. The user, thus, needs to carry out only one step, specifically of placing the finger onto a contact surface. The procedure is analogous when using other biometrically measurable body parts (retina etc.); the only condition is that the user brings his body into touch contact with a coupling surface, or a body part or the portable device into the vicinity of this. The maximal distance at which a capacitive coupling is still sufficiently definitive depends on the amplitude of the voltage. It may be 50 cm; with preferably applied amplitudes, it may be a few cm, for example maximally 10 cm, also more depending on the circumstances (relative orientation of the objects, conductivity of the ground and footwear, etc.).

The method according to the invention is specially suitable for systems with security hierarchies: for the lowest security level—for example for opening doors within a building in a business—under certain circumstances, where the transmission of a few bytes is sufficient. The first information transfer is sufficient for this. In contrast, for higher security levels and for protocolling, one operates with the inventive combination of the first and the second information transfer.

Although it was assumed in the preceding examples that a coupling surface is touched by the user by hand or the user holds his hand in the vicinity of this surface, this is not at all necessary. Indeed, the method according to the invention is particularly well suitable for hands-free applications. The user for example may open a door with the shoulder without further ado; the door then has a coupling surface, and the coupling is effected via the shoulder. It is also conceivable for the user to hold the portable device itself in the vicinity of the coupling surface.

### BRIEF DESCRIPTION OF THE DRAWINGS

Embodiment examples of the invention are hereinafter described in more detail by way of the drawings. In the drawings there are shown in:

FIGS. 1 and 2 in a very schematically manner, possible implementations of a portable device according to the invention, for carrying out the method according to the invention,

FIGS. 3 to 7 procedural diagrams of embodiments examples of the method according to the invention,

FIGS. 8 to 11 sketches for illustration of possible applications,

FIG. 12 a further possible implementation of a portable device according to the invention.

### DETAILED DESCRIPTION OF THE INVENTION

Generally, for the method according to the invention, the information transfer is carried out between a unit called here a “write- and/or read installation” and a unit here called “portable device”. This unit may consist of one or more components which are coupled by a communication connection and are arranged together with one another or at different locations. The write- and/or read installation may be coupled to an object (transport means for example) in a stationary manner or be freely transportable. It comprises a means for communication via a capacitive coupling, for example via the human body. In many embodiments, this means is a “capacitive” receiver. A coupling surface is allocated to the write- and/or read installation for the capacitive communication—mostly with the human body as a transmission medium, and this surface is preferably but not necessarily metallic (a metallic surface may also be protected by plastic or glass).

Apart from this, the write- and/or read installation according to a first embodiment of the invention also comprises a module for communication via electromagnetic induction or via electromagnetic waves. This module is hereinafter called “transceiver”. The transceiver may be designed in a known manner as RFID- UHF-, IR- etc. transceiver.

The means for communication via the human body and the receiver are coupled to one another with regard to communication. They may, but need not be arranged in a common housing. The term write- and/or read installation (or write- and/or read device) as a result does not imply that that means for communication via the human body and the transceiver are physically located at the same location.

According to a second embodiment of the invention, a module comprising the transceiver, for communication via electromagnetic waves, may also be present in an apparatus which is completely separate from the means for communication via the human body, i.e. not coupled on-line with regard to communication. A data exchange between the transceiver and the write- and/or read installation then takes place off-line, i.e. at a different point in time than the point in time of the data transmission with the portable device. This will yet be explained in more detail by way of an embodiment example of the invention described in the following.

The portable device or tag, is carried by the user close to the body. It is preferably designed in a thin and card-like manner. It comprises a means for the primary capacitive communication, for example via the human body, as well as an active (i.e. with its own energy supply (battery)) or passive means (transformer), for communication with the transceiver via electromagnetic induction or via electromagnetic waves. In the case of a passive transponder, the means for capacitive communication may likewise be supplied in an inductive manner. In both cases (active-passive), the energy supply of the means for the capacitive communication and of the means for the contactless communication may be a common one (common battery, aerial etc.).

Systems with RFID-, UHF-, IR- etc. transceivers and corresponding passive or active transponders have been known for some time and are obtainable on the market in numerous embodiments, price groups and security levels. The embodiments of the system Legic® are mentioned as such an example. The details of these means for the “contactless” communication are not dealt with in detail hereinafter.

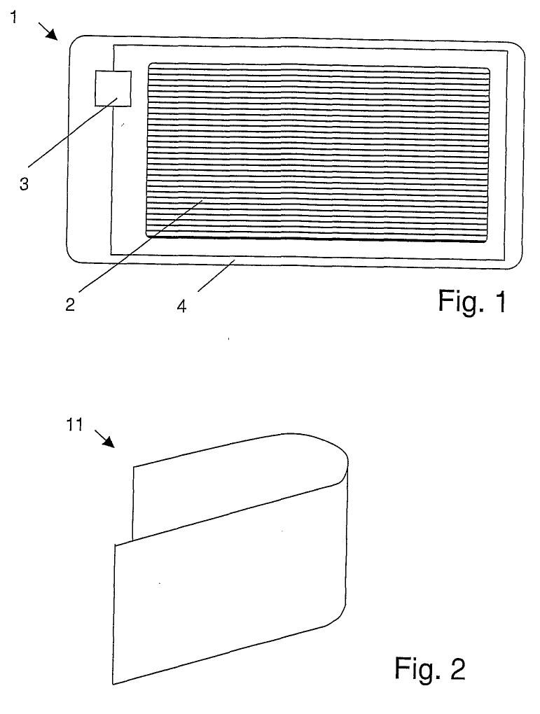

The means for the capacitive and contactless communication of the portable device are preferably integrated in a single element, which may be designed as a card or a comparable object, as is illustrated in FIG. 1. FIG. 1 very schematically shows a portable device 1 with a two-dimensionally designed electrode 2 for capacitive information transmission. A second electrode (not visible) which runs parallel to the first electrode is allocated to the electrode 2. An alternating voltage is applied between the two electrodes by way of control means for the transmission of information. The portable device also has a passive RFID-chip 3 and an aerial 4 coupled thereto, for contactless communication. A communicative coupling may be present between the RFID-chip and the control means; this however is not necessary. Under certain circumstances, it is sufficient for the RFID-chip to be recognised in the write- and/or read installation by way of an identification code sent by the control means, and for it to be addressed or unambiguously identified with the following second information transmission, which will yet be explained in more detail hereinafter.

According to a special embodiment, the portable device 11 is designed two-dimensionally thin and pliable, for example in the manner of a bank note, which is shown very schematically in FIG. 2. Such an embodiment permits comparatively high capacitances, if for example the two electrodes are arranged on the right and left on the portable device 11. Furthermore, it fits ideally into the wallet of the user.

Other designs of the portable device are also conceivable. The “tag” may, for example, be designed as a module which may be installed into a higher-ranking portable device (wrist watch, palmtop, mobile telephone, etc.) and communicates with this higher-ranking portable device—for example in the described manner- and is preferably fed by this. The single-part design of the portable device although being preferred, is however not a necessity. Thus, under certain circumstances, the means for the capacitive information transmission may be arranged in an element which is separate to the means for contactless information transmission. It must then be ensured in a suitable manner that the user always carries along the elements belonging to one another—for example by way of corresponding instructions and by labelling the elements.

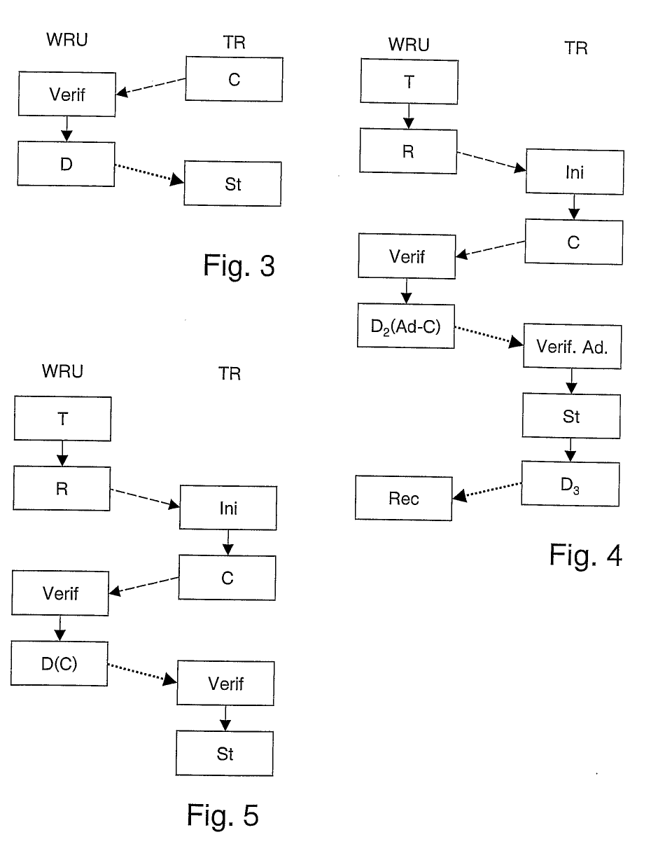

In the FIGS. 3 to 7, WRU indicates the write- and/or read installation and TR indicates a portable device which is carried by the user. In the representation, dashed lines are used for the data transmission via the human body, and dotted lines for the “contactless” (RF, microwave, inductive, etc.) data transmission.

According to FIG. 3, an identification code C is transmitted to the write- and/or read installation from the portable device via the body of the user, given a coupling between a coupling surface envisaged therefore and the user. This, for example, is a unique identification number of the portable device, and permits the identification of the portable device by the write- and/or read installation. Subsequent to the transmission, the write- and/or read installation, by way of the identification signal, verifies (Verif) as to whether the portable device (or its carrier) is authorised for the desired procedure. If this is not the case, the method is terminated. If however the portable device is authorised, the write- and/or read processes (within the framework of the second information transmission) may take place between the write- and/or read installation and the portable device. In the drawn example, these consist of a single write process on the portable device on which data D may be stored (St). As the case may be, further events, for example a clearance, may be activated, supplementarily to the write- and/or read process or subsequent to these.

Depending on the application, it may also be requested that an identification code C be transmitted from the write- and/or read installation to the portable device, or that an identification is effected on both sides by way of two identification codes C1, C2, before the write- and/or read processes.

The surface to be touched by the user may be a metal surface which is distinguished as such, for example a metal surface which is marked by way of a frame which is highlighted with regard to color. Alternatively, it may also be part of the surface of an object which is touched in any case by the user within the framework of the executed action, for example of a door latch, a door knob or a means acting in a similar manner, a keypad or a touch screen, etc.

In the above embodiment, it is yet to be ensured that the system is indeed active at the moment of touching by the user. The portable device or the write- and/or read installation may, for example, be set up such that they continuously and periodically emit an identification signal. The respective receiver, i.e. the write and/or read installation or the portable device may likewise be continuously active and in a receiving mode, or the identification signal also serves as a wake-up signal for the receiver. Other embodiments for the waking-up of the portable device and/or write- and/or read installation electronics are of course also conceivable, for example the continuous and periodic emission of weak wake-up signals. However, the embodiment in which the write- and/or read installation is woken up by a contact sensor is particularly preferred. Such an embodiment is for example based on the fact that a human body acts as an aerial which captures a multitude of disturbances in the electromagnetic field of the surroundings. With a capacitive coupling between the surface—this acts as an electrode—and the user (for example with a touching of the surface or its covering by the user), the disturbance signals on this increase massively compared to the contactless condition. These disturbance signals may be used as a trigger, by way of which the electronics of the write- and/or read installation may be shifted from a standby mode into an operating mode.

The activated write- and/or read installation, if necessary, may “wake up” the electronics of the portable device by way of a suitable signal R. An explicit wake-up signal is, however, not absolutely necessary at least in the cases of short-range systems with portable devices without batteries. Rather, in such systems, under certain circumstances, it is sufficient for the activated write- and/or read installation to begin emitting an excitation signal. The portable device may be designed and programmed such that it is always in an active condition on receipt of an excitation signal.

The above-described possibilities for the “wake-up” method as well as further methods known per se may be applied in the embodiment form according to FIG. 3 as well as in all other embodiment forms of the invention. In the following example, for the sake of simplicity, it is always assumed that the write- and/or read installation is woken up by detection T of the increased disturbance signal on coupling with the user, and subsequently sends a wake-up signal to the portable device.

A first embodiment which has implemented this principle of a wake-up device is drawn in FIG. 4. After a touching (or almost touching) has been ascertained (T) by the write- and/or read installation, this via the body of the user sends a wake-up signal R to the portable device. The transfer of the first and second information subsequently begins. In the example according to FIG. 4, this transfer contains the forwarding of an identification code C as in FIG. 3, and the subsequent checking of the authorisation (Verif). In contrast to the embodiment according to FIG. 3, the transfer of the data D₂ from the write- and/or read installation to the portable device is however effected addressed to the sender of the of the identification code C. The address may consist of the identification code itself or be selected from the write- and/or read installation by way of the identification code. The addressed data is indicated in the figure at D₂(Ad-C). This addressing permits additional security: the receiver (the portable device) may verify (Verif.) as to whether the transmitted data D₂ is indeed envisaged for it. The method is terminated if this is not the case. By way of this second examination, one may rule out a portable device which by chance happens to be in the vicinity, from being inadvertently written. For example, with ticketing applications, one may avoid an access card being inadvertently validated (stamped). The embodiment of FIG. 4 additionally contains a further information transmission from the portable device to the write- and/or read installation (Data D₃). This may for example contain a confirmation to the write- and/or read installation, whereupon the storage procedure is successfully completed, and its recording (Rec) may be a necessary condition for the activation of an event (for example the opening of an access). Furthermore, further data may be called up from the portable device either as an alternative to this or supplementary thereto.

The embodiment of FIG. 4, compared to that of FIG. 3, ensures an increased reliability also in cases in which, on account of the geometric arrangement, it is not guaranteed that the transmission of the first information takes place between the same participants as the transmission of the second information. However, depending on the circumstances, it is not secure from manipulation.

FIG. 5 shows a system which in comparison to that of FIGS. 3 and 4 comprises an additional security element by way of which it is particularly ensured that no unauthorised write- and/or read installation writes data onto the portable device. This additional security is important, for example, if the portable device serves as a charge card and amounts are to be credited or debited.

As in the embodiment according to FIG. 4, a wake-up signal R is sent subsequent to ascertaining a capacitive coupling of the user to a coupling surface, whereupon an identification code C is transmitted from the portable device to the write- and/or read installation via the body, and this code may be subsequently verified. In contrast to the method according to FIG. 4, the information which is subsequently written onto the portable device (or its data memory) is processed such that the data D is a function of the identification code C and may only be read on recognition of this. The identification code or a variable dependent thereon may, for example, serve as a key on encoding the data. The encoding function has been previously fixed and known only to the authorised write- and/or read installations and portable devices. The security may be additionally increased if the identification code C and/or the encoding function is not constant, for example time-dependent.

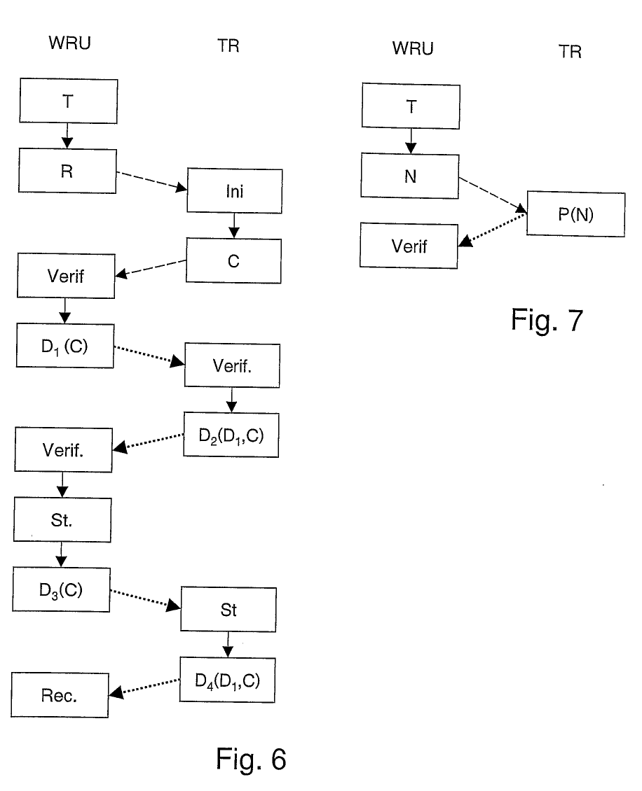

This principle of the additional security by way of encoding a capacitively transmitted key may be extended further. FIG. 6 shows a method with which a first data package D₁(C) transmitted to the portable device according to the procedure according to FIG. 5, contains a key. This serves for encoding the following data packages D₂, D₄ transmitted from the portable device to the write- and/or read installation. The identification code C, the key contained in D₁ or another key transmitted or set previously may be used for the data transfer in the other direction, i.e. from the write- and/or read installation to the portable device. Preferably, as shown in FIG. 6, each data package transmitted in a contactless manner is in some way directly or indirectly dependent on capacitively transmitted data (on the identification code C in the figure). By way of this, it is ensured that the complete data exchange between the initial participants takes place, even if for example several portable devices are located in the vicinity of a write- and/or read installation. A dependence on capacitively transmitted data may also concern technical features of the transmission, for example the selection of a carrier frequency, a reference for the spread spectrum, signal transmission, etc.

“Verif” in FIG. 6—just as with the other figures—indicates a verification, for example in the form of a comparison, “St” indicates a write process, “Rec” a recording of a completed procedure.

As in the embodiment according to FIG. 4, a confirmation to the write- and/or read installation may be effected after the completed storage process, under certain circumstances also in an encoded manner.

The procedure according to the invention permits the use of the application of practically any authentication/authentification- or encoding method, which are known per se or are yet to be developed, or other types of secured information exchange. The example of the access control by way of a challenge response method known per se is yet drawn in FIG. 7. The write- and/or read installation—this for example is coupled to a cylinder lock—capacitively transmits a first data package to the portable device. The first data package consists, for example, of a random number N or contains such. The portable device processes this data package (random number N) for example by way of an encoding method, and returns a processed value P(N). The write- and/or read installation comprises means to verify the correct processing P of the data package.

In the shown example, the transmission of the “challenge” is effected in a capacitive manner, that of the “response” in a contactless manner, i.e. inductively or via electromagnetic waves. Depending on the application, information is yet exchanged subsequent to the authentification of the portable device—under circumstances also prior to this—for example together with a clearance result, preferably in a contactless manner. In such cases the “response” may be transmitted capacitively.

Selected applications of the method according to the invention in its various designs are discussed hereinafter. Simultaneously, the preferred procedure for implementing these applications and the advantages of this procedure are explained. The invention however is in no way limited to the selected applications cited hereinafter.

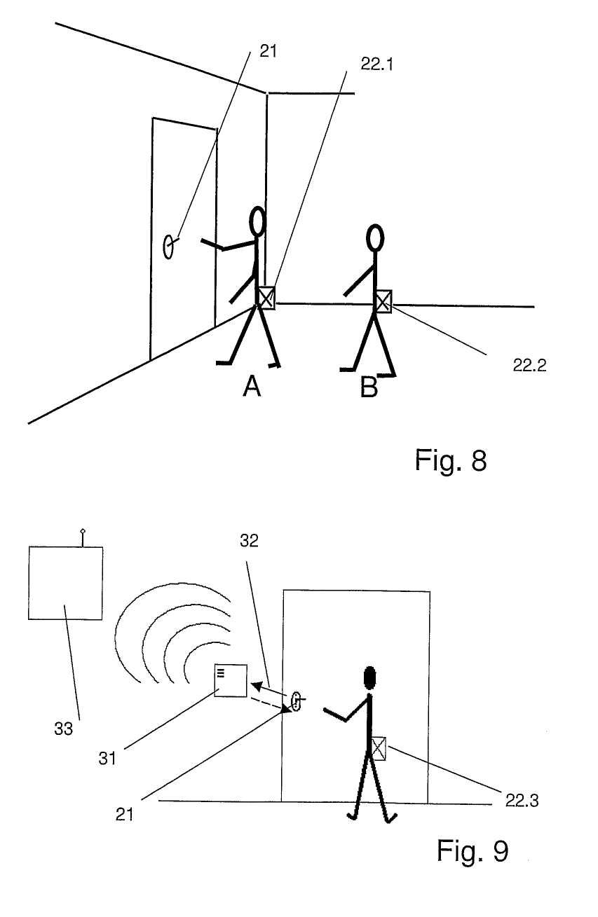

The application “access control” for the simplest case is illustrated in FIG. 8. Two persons A, B each carry along a portable device 22.1, 22.2 as a badge. Person A touches the door handle 21 which has an at least partial metallic surface and functions as an electrode. Person A is selected by way of this, and an identification code of the portable device 22.1 is capacitively transmitted to the write- and/or read installation, to which an electrode is coupled and which is not shown in the figure. If the identification code corresponds to the set criteria (i.e. the carrier of the badge is authorised to access), the emitting of an electromagnetic alternating field is initiated by the write- and/or read installation. Data is transmitted to the portable device by way of this. The energy supply of the RFID-component (or UHF-, IR- etc. component) of the portable device may be effected by the alternating field. The transmitted data directly or indirectly contains the identification code. The portable device only executes write processes with received data when this contains the correct identification code. Data may also flow in the reverse direction—thus from the person A to the write- and/or read installation. In the case that the RFID-component (or UHF-, IR-, etc. component) of the portable device (the transponder) is passive, this may for example be effected by way of load modulation on the part of the portable device. The reciprocal communication may for example contain a checking of the access authorisation of person A on a higher security level that the mere transmission of a number (code). Additionally, the access may be protocolled on the portable device. Due to the fact that all or at least some of the exchanged data packages are dependent on the identification code, one prevents the write- and/or read installation from inadvertently communicating with the portable device of the person B. By way of this, one efficiently prevents a non-authorised person A from gaining access with an existing access authorisation of the person B.

The means for the communication via the human body and the module for the contactless communication may be locally separated from one another for the application “access control” and also for other application, as is illustrated in FIG. 9. The means for communication via the human body is integrated for example in the lock which also comprises the door handle 21. A communication exists between these means and the module 31 for the contactless communication, by way of which data may be transmitted at least in one direction, which is illustrated by the arrows 32. The transponder of the portable device as in the previous example may be passive and by way of this have a short range. A central communication 33 is also drawn in FIG. 9, to which the module has a communication connection. This module may, for example, be connected to a central computer, which protocols all procedures (each opening of the door etc.), calls up information stored on the portable device, and/or by way of which updates of the information stored on the portable device may be carried out. The central communication unit may also be connected to the control of other objects, and activate further events after a clearance, such as for example the opening of a garage door etc.

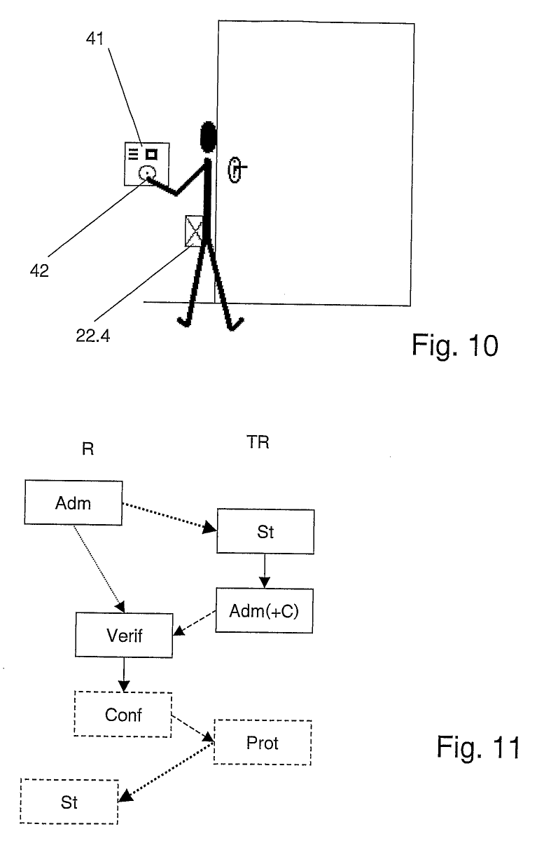

The write- and/or read installation 41 of the system according to FIG. 10 is provided with a sensor 42 with which a fingerprint of a user may be detected. A so-called “template”—a data-compressed representation of the fingerprint—may be evaluated from the readings of the sensor. The surface of the sensor, for example, simultaneously serves as an electrode for the capacitive data transmission. The portable device 22.4 which is carried by the user has a data memory on which the template of the user computed at an earlier point in time is stored. If the user wishes to gain access, a data exchange is set into motion as with the previous example, which begins with the transmission of an identification code from the portable device 22.4 to the write- and/or read installation via the human body of the user. In contrast to the previously mentioned examples, the transmission of the second information however contains the transfer of the stored template from the portable device to the write- and/or read installation. There, the template evaluated by the sensor is compared to the stored template. A clearance is only effected on agreement. This application thus apart from the verification that the data exchange is effected with the “correct” portable device, also contains an assurance that the portable device is carried by the authorised person.

The embodiment example of FIG. 11 is specially suitable for centrally controlling the access authorisation to objects. It may then also be applied if the objects are not in a constant communication connection with the central location. An access code (Adm) is transmitted to the portable device via the second communication channel in a first step. This is particularly preferably effected by way of coupling the portable device to a telecommunication means—for example a fixed network telephone module or a GSM- or UTMS-terminal, or provided with a corresponding module. The access code is sent to the portable device via the telecommunication network. This may be effected at any point in time, and the user thereby does not need to be located in the vicinity of write- and/or read installation. The access code is stored by the portable device (St).

The access code may authorise the access to an object, said access being unlimited or limited with regard to time, one-off, repeated or unlimited. It may be dependent on the portable device and only be utilised by this, in that this device, for example, further transmits the access code in a manner which is dependent of the identification code C specific to the device.

The checking of the access authorisation is effected by way of data transmission from the portable device to the write- and/or read installation on the first communication channel, i.e. in a capacitive manner.

This embodiment may be used, for example, to book a hotel room directly via the telephone, for example mobile phone. An access code is transferred from the central unit to the personal portable device, and this authorises the access to a hotel room for a certain time. The locking devices of the hotel room may be in constant communication connection with the central unit, by which means the central unit directly manages the access authorisations and, as the case may be, may also protocol access and irregularities. In this case, the write- and/or read installation is composed of a module of the locking device as well as the central unit. As an alternative, one may also do away with a constant communication connection between the central unit and the locking devices. The write- and/or read installation is then located (only) in the closure device. The (under certain circumstances indirect) communication between the closure device and the central unit is effected “offline”, for example by way of programming a number of codes authorising access, into the write- and/or read installation, which are also known to the central unit. This “offline” communication is indicated in the figure by way of the finely dotted arrow.

A second application example of this embodiment is the trade with properties. In some countries, it is common to provide prospective buyers with access to a property for a certain time. This at present is often effected by informing the prospective buyer of a code which he must then enter via a keypad field at the location of the property. The invention permits an access code to be transmitted directly to the portable device, and the prospective buyer only need to carry the portable device with him in order to obtain access to the property.

One may yet optionally envisage a protocol of the access—where appropriate in combination with a debit confirmation, a validation (stamping), etc. is to be transmitted to the central unit. This, as is shown in the Figure, may be effected via the second communication channel—this for example via a telecommunication connection—after a confirmation has been confirmed to the portable device by the write- and/or read installation.

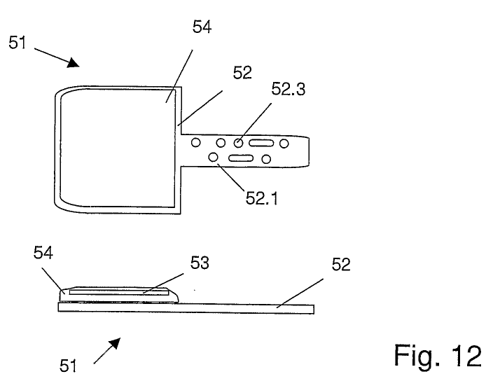

FIG. 12 shows a further special embodiment of the portable device 51. The figure shows the portable device 51 in a plan view and in a sectioned representation. The portable device 51 thereby is formed as a key. A metallic key-base part 52 on which a key shank 52.1 is formed, apart from its cylinder opening function, simultaneously serves as a an electrode. The key shank may have coding bores 52.3 in a manner known per se, which cooperate with corresponding mechanical tumblers of a cylinder lock. Other coding devices may be present on the key as an alternative or supplementary to this. The second electrode 53 is arranged in the inside of a key housing 54 which also comprises the necessary electronics (not shown) for the storage, the receipt and/or sending data, as well as aerial elements as the case may be, etc.

Such a key simultaneously serving as a portable device has many application possibilities. Thus the access authorisation in a building may for example be controlled such that at least some of the doors within the building as well as possibly also outer accesses to the building may be opened without a key, at least during the day. This may be effected in that information is transmitted between a write- and/or read device of the lock cylinder in the manner according to the invention, and the door is released depending on this. The user may, thus, move in the building and enter the rooms to which he has access, without having to have the key in his hand. At least during the night, one may envisage a door lock having to be activated mechanically and/or mechatronically with the key on doors with an increased security requirement.

Of course, individual properties may also be accessible only by way of capacitive information transmission, others only in a conventional manner.

The information transfer between the key 51 and a cylinder lock may also take place via the second communication channel in the manner of the already known safety modules communicating inductively and/or via electromagnetic waves, wherein—for selected applications—information transferred via the first communication channel may serve as a necessary precondition for the transmission of information via the second communication channel.

The embodiment of the portable device according to FIG. 12 may also be applied in cases in which no information transfer via a second communication channel takes place. The portable device also in this case however has at least
one metallic key base part 52, on which a key shank is formed, which may be introduced into a corresponding opening of the cylinder lock,
and a second electrode 53,
wherein the key base part and the second electrode may be activated by electronics of the portable device such that they may serve as a first and second electrode for capacitive information transmission,
and wherein preferably a data memory is allocated to the key electronics or is integrated into these.

Many further embodiments are also conceivable.

Induction/electromagnetic waves (preferred media for the second information transmission channel): even if a coupling (inductively/electromagnetic waves) dominates at a certain distance between the write- and/or read installation and the portable device, it is however to be understood that the two information transmission types merge into one another depending on the selected carrier-frequency/distance. Furthermore, the invention does not rule out the information being transmitted at different frequencies, so that mainly inductive as well as mainly electromagnetic information transmission may take place simultaneously or one after the other. The information transmission by way of induction and/or electromagnetic waves may correspond to the information transmission on an existing information transmission channel, and where appropriate use its protocols and/or auxiliary means. The information transfer may in particularly be effected via GSM, UTMS or with comparable means.

1. A method for the transmission of identification signals and/or information, by way of at least one write- and/or read installation and at least one portable device carried by the user, wherein information is transmitted via two communication channels, and wherein the information transmission via the first communication channel is effected capacitively.

2. A method according to claim 1, wherein the information transmission via the second communication channel is effected inductively or by way of electromagnetic waves.

3. A method according to claim 1, wherein the information transmission via the first communication channel as well as the information transmission via the second information channel is effected between the write- and/or read installation and the portable device.

4. A method according to claim 1, wherein the information transmission via the first communication channel is effected between the write- and/or read installation and the portable device, and the information transmission via the second communication channel is effected between a device which with regard to location is distanced from the write- and/or read installation, and the portable device.

5. A method according to claim 1, wherein information which may be used for identification and/or selection of the user, is transmitted via the first communication channel.

6. A method according to claim 1, wherein a coupling surface is allocated to the write- and/or read installation, and that a first information transmission takes place via the first communication channel, and a second information transmission takes place via the second communication channel, as soon as the user or the portable device touches the coupling surface or at the most is located at a maximal distance thereto.

7. A method according to claim 1, wherein a first information transmission via the first communication channel is a necessary precondition for the transmission of information via the second communication channel.

8. A method according to claim 7, wherein data transmitted with the second information transmission depends on data which has been transmitted with the first information transmission.

9. A method according to claim 8, wherein at least one data package transferred with the second information transmission at least partly contains data transmitted with the first information transmission.

10. A method according to claim 8, wherein data transmitted with the first information transmission serves as a key for encoding data which is transmitted with the second information transmission.

11. A method according to claim 1, wherein an identification code of the portable device is transferred from the portable device to the write- and/or read installation with the information transmission via the first communication channel, and that only the identification code is transmitted from the portable device to the write- and/or read installation, preferably via the first communication channel.

12. A method according to claim 1, wherein data transmitted from the portable device to the write- and/or read installation via the first communication channel and/or via the second communication channel is compared to stored values, and that the user is authorised to access an object given a desired agreement and possibly upon fulfilling further conditions.

13. A method according to claim 1, wherein data is transmitted from the write- and/or read installation to the portable device via the second communication channel, and that this data is stored by the portable device.

14. A method according to claim 13, wherein the portable device serves as an entrance ticket or travel ticket and that the storage of data in the portable device includes the debiting of a unit of value or the stamping of an entrance ticket or travel ticket.

15. A method according to claim 1, wherein a template with biometric data of the user is transmitted from the portable device to the write- and/or read installation via the second communication channel.

16. A method according to claim 1, wherein an unselective and/or unspecific information exchange for preparing the transmission of information via the second information channel takes place before the transmission of information via the second information channel, for the synchronisation and construction of the second information channel.

17. A method according to claim 1, wherein the write- and/or read installation is woken up by a capacitive coupling of the user with a coupling surface of the write- and/or read installation.

18. A method according to claim 1, wherein energy is transmitted inductively from the write- and/or read installation to the portable device during the information transmission and/or before the information transmission, and that this energy is at least partly used to transmit information from the portable device via the first communication channel to the write- and/or read installation.

19. Identification- and/or information transmission system, comprising at least one write- and/or read installation and at least one portable device with a data memory, wherein the write- and/or read installation and the portable device contain means for the transmission of information between the write- and read installation and in each case one of the portable devices,
wherein the write- and/or read installation comprises a first means for receiving and/or sending data from or to the portable device via a capacitive coupling,
and that the portable device contains corresponding first means for sending and/or receiving data to and from the write- and/or read installation via a capacitive coupling, as well as second means for sending and/or receiving data by way of induction or electromagnetic waves.

20. A system according to claim 19, wherein the write- and/or read installation further comprises a second means for receiving and/or sending data from or to the mentioned portable device by way of induction or electromagnetic waves.

21. A system according to claim 20, wherein the second means of the write- and/or read installation comprise a radio frequency-, microwave frequency- or infrared-transceiver, and the second means of the portable device comprise a radio frequency-, microwave frequency- or infrared-transponder.

22. A system according to claim 19, wherein the portable device forms a card-like or paper-like unit, into which the first and the second means are integrated.

23. A write- and/or read installation for a system according to claim 20, further comprising a data memory and a data processing unit as well as a first means for receiving and/or sending data from or to a portable device via a capacitive coupling, and a second means for receiving and/or sending data from or to the mentioned portable device by way of induction or electromagnetic waves.

24. A portable device for a system according to claim 19, further comprising a data memory as well as first means for sending and/or receiving data to or from a write- and/or read installation via a capacitive coupling, and a second means for sending and/or receiving data by way of induction or electromagnetic waves
